(19) United States
(12) Patent Application Publication
(10) Pub. No.: US 2024/0034352 A1
(43) Pub. Date: Feb. 1, 2024

(54) METHOD AND DEVICE FOR IMPROVING AUTONOMOUS DRIVING PROFILE OF AUTONOMOUS VEHICLE

(71) Applicant: SAMSUNG ELECTRONICS CO., LTD., Suwon-si (KR)

(72) Inventors: Dohyoung KIM, Suwon-si (KR); Jinah KONG, Suwon-si (KR); Jaeyeon RHO, Suwon-si (KR); Yongjun LIM, Suwon-si (KR); Younju JIN, Suwon-si (KR)

(21) Appl. No.: 18/375,897

(22) Filed: Oct. 2, 2023

Related U.S. Application Data
(63) Continuation of application No. PCT/KR2022/003644, filed on Mar. 16, 2022.

(30) Foreign Application Priority Data
Apr. 2, 2021 (KR) 10-2021-0043300

(51) Int. Cl. B60W 60/00; B60W 40/08

(52) U.S. Cl. CPC B60W 60/001; B60W 40/08; B60W 2540/221; B60W 2540/22; B60W 2540/223

(57) ABSTRACT

An autonomous driving control device according to various embodiments includes a sensor device including a biosensor, and a processor, wherein the processor is configured to control, as a first parameter value, a parameter related to a driving device for controlling a movement of an autonomous vehicle when the autonomous vehicle is driving with at least one autonomous driving function. The processor is also configured to monitor, via the biometric sensor, mental and physical states of an occupant on the basis of biometric information of the occupant located in the autonomous vehicle while the autonomous vehicle is driving with the autonomous driving function and adjust the first parameter value to a second parameter value in response to a change in the mental and physical states of the occupant from a stable state to an unstable state as a result of monitoring the mental and physical states of the occupant.

### CROSS-REFERENCE TO RELATED APPLICATION(S

This application is a continuation application, claiming priority under § 365(c), of International Application No. PCT/KR2022/003644, filed on Mar. 16, 2022, which is based on and claims the benefit of Korean patent application number 10-2021-0043300 filed on Apr. 2, 2021, in the Korean Intellectual Property Office, the disclosures of which are incorporated by reference herein in their entireties.

### BACKGROUND

Various embodiments relate to a method and a device for improving an autonomous driving profile of an autonomous vehicle.

An autonomous system or an advanced driver assistance system (ADAS) refers to a system capable of autonomously driving a vehicle to a destination by recognizing the driving situation without intervention of the driver (or occupant), and autonomous vehicles have recently been drawing increasing attention as a future means of transportation.

An autonomous vehicle may be configured to perform recognition, assessment, path generation, and vehicle control operations. However, the autonomous vehicle controls vehicle movements based on configured values, regardless of the occupant's inconvenience, and each occupant may thus feel uncomfortable with driving by the autonomous vehicle. For example, vehicle occupants (or drivers) have driving habits determined by individual tendencies, and respective occupants may thus have different emotions and different physical inconveniences in the same driving situation. In other words, some occupants may feel stable, while other occupants may feel anxious, even at the same speed.

In addition, even if there is no risk of collision during autonomous driving, some occupants may be anxious in unexpected situations such as abrupt vehicle movements, periodically repeated sudden car stops, and sudden unintended accelerations.

### SUMMARY

Various embodiments may provide a method and a device wherein the mental/physical state of an occupant (or driver) is assessed in an autonomous driving situation, and the situation-specific autonomous driving profile is improved into a personally customized profile while reflecting the personal situation and the mental/physical state of the occupant.

An autonomous driving control device according to various embodiments includes a sensor device including a biosensor, and a processor, wherein the processor may be configured to: control, as a first parameter value, a parameter related to a driving device for controlling a movement of an autonomous vehicle when the autonomous vehicle is driving with at least one autonomous driving function; monitor, via the biometric sensor, mental and physical states of an occupant on the basis of biometric information of the occupant located in the autonomous vehicle while the autonomous vehicle is driving with the autonomous driving function; and adjust the first parameter value to a second parameter value in response to a change in the mental and physical states of the occupant from a stable state to an unstable state as a result of monitoring the mental and physical states of the occupant.

An autonomous driving control device according to various embodiments includes a communication module; and a processor operatively connected to the communication module, wherein the processor is configured to: connect to an electronic device of an occupant positioned inside an autonomous vehicle through the communication module, control a parameter related to a driving device configured to control movements of the autonomous vehicle at a first parameter value when the autonomous vehicle is driven by at least one autonomous driving function, identify a transition of the occupant's mental/physical state from a stable state to an unstable state, based on biometric information transferred from the electronic device, while being driven by the autonomous driving function and adjust the first parameter value to a second parameter value in reaction to a transition of the occupant's mental/physical state from a stable state to an unstable state.

An autonomous driving control device according to various embodiments includes a memory and a processor operatively connected to the memory, wherein the memory comprises instructions which, during autonomous driving, cause the processor to, operate a parameter related to a driving device at a first parameter value according to at least one autonomous driving function so as to control movements of an autonomous vehicle, monitor an occupant's mental/physical state, based on biometric information of an occupant positioned inside the autonomous vehicle and adjust the first parameter value to a second parameter value such that the occupant's mental/physical state becomes stable in reaction to a transition of the occupant's mental/physical state from a stable state to an unstable state as a result of monitoring the biometric information.

According to various embodiments, a change in emotional state of an occupant (or driver) in an autonomous vehicle may be sensed, the driving pattern and the degree of driving may be adjusted in a situation in which the occupant feels anxious during autonomous driving, and the same may be continuously updated, thereby providing a personally customized comfortable ride as the autonomous driving experience increases.

According to various embodiments, a biometric sensor may be mounted in an autonomous vehicle, or an electronic device equipped with a biometric sensor may be used to assess the mental/physical state of an occupant, and the autonomous driving function control value may be adjusted by recognizing the correlation between a change in the mental/physical state of the occupant and the driving situation, thereby improving the autonomous driving profile according to the personal characteristics of the occupant such that he/she does not feel anxious.

### BRIEF DESCRIPTION OF DRAWINGS

FIG. 1 is a block diagram illustrating an example electronic device in a network environment according to various embodiments.

FIG. 2 illustrates the configuration of an electronic device and an autonomous vehicle according to various embodiments.

FIG. 3 illustrates an electronic device and a method for improving an autonomous driving profile of an autonomous driving vehicle according to various embodiments.

FIG. 4 illustrates a method for improving an autonomous driving profile of an autonomous vehicle according to various embodiments.

FIG. 5 illustrates the configuration of an autonomous vehicle according to various embodiments.

FIG. 6 illustrates a method for improving an autonomous driving profile of an autonomous vehicle according to various embodiments.

FIG. 7 illustrates a method for improving an autonomous driving profile of an autonomous vehicle according to various embodiments.

FIG. 8 illustrates a method for improving an autonomous driving profile of an autonomous vehicle according to various embodiments.

FIG. 9 illustrates an example of improving an autonomous driving profile of an autonomous driving vehicle according to various embodiments.

FIG. 10 illustrates an example of improving an autonomous driving profile of an autonomous driving vehicle according to various embodiments.

### DETAILED DESCRIPTION

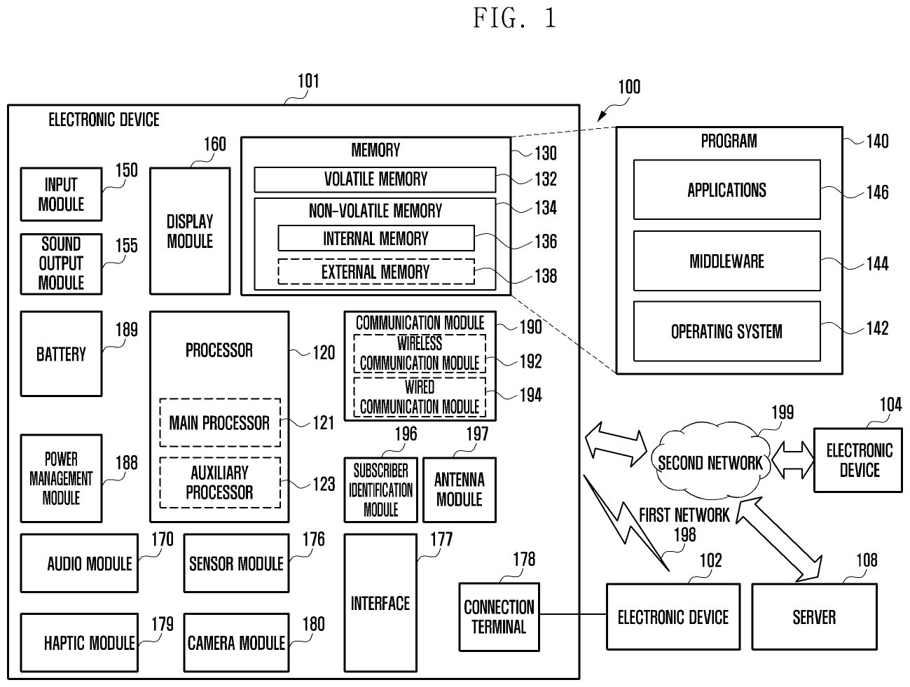

FIG. 1 is a block diagram illustrating an example electronic device 101 in a network environment 100 according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and/or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 and/or the non-volatile memory 134. The non-volatile memory 134 may include an internal memory 136 and/or an external memory 138.

The program 140 may be stored in the memory 130 as software, and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, and/or flashes.

The power management module 188 may manage power supplied to and/or used by the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, a fuel cell, or a combination thereof.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a millimeter (mm) Wave antenna module. According to an embodiment, the mmWave antenna module may include a printed circuit board, a radio frequency integrated circuit (RFIC) disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to various embodiments, the electronic device 101 is applicable to an intelligent service (for example, a smart home, a smart city, a smart car, or health care) based on 5G communication technologies and IoT-related technologies.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like.

According to an embodiment, the electronic device 101 may refer to a wearable device or a smart device configured to communicate with an autonomous vehicle. For example, the electronic device 101 may communicate with an autonomous driving control device included in the autonomous vehicle, thereby administering an autonomous driving policy of the autonomous vehicle. The autonomous vehicle may refer to a vehicle capable of performing an autonomous driving function through a transportation means for transporting passengers or cargo by using power generated by an engine, but is not limited thereto, and may include any means of mobility, including an autonomous driving system.

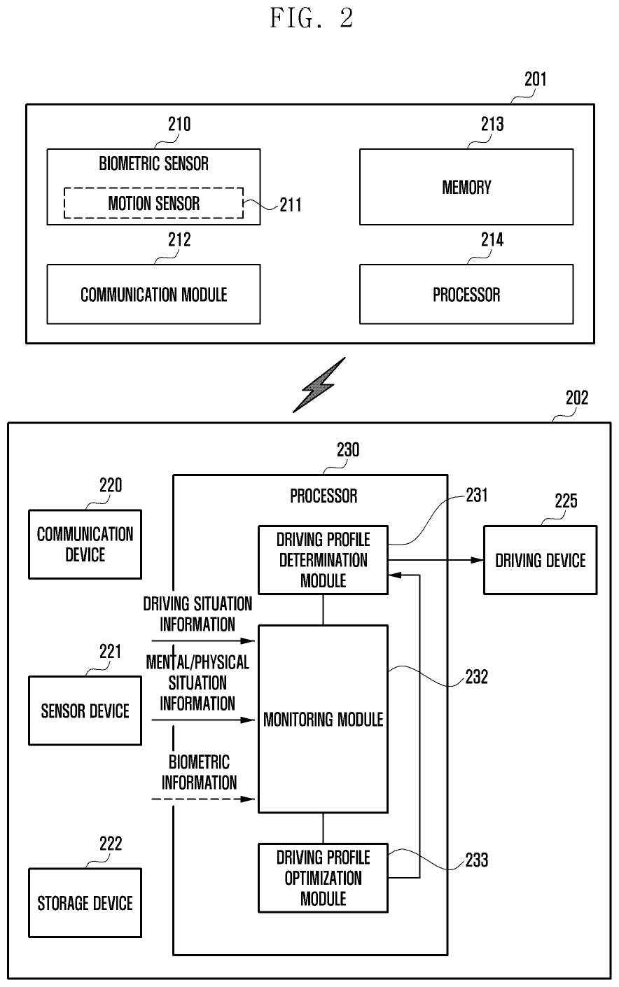

FIG. 2 illustrates the configuration of an electronic device and an autonomous vehicle according to various embodiments.

Referring to FIG. 2, according to an embodiment, the electronic device 201 (for example, the electronic device 101 in FIG. 1) may be connected to, so as to communicate with, the autonomous vehicle 202. For example, the electronic device 201 may be connected to, so as to communicate with, an autonomous driving control device configured to control at least some operations related to autonomous driving of the autonomous vehicle 202, thereby transmitting/receiving data or signals related to autonomous driving.

As an example, the electronic device 201 may be a smartphone or a wearable device (for example, a watch type, a band type, or a glass type) configured to communicate with the autonomous vehicle 202. The electronic device 201 may include a biometric sensor 210, a communication module 212, a memory 213, and a processor 214. The electronic device 201 may further include at least one of the components and/or functions of the electronic device 101 in FIG. 1, and may include components overlapping those in FIG. 1.

The biometric sensor 210 may generate a biometric signal corresponding to biometric information related to a user (i.e., an occupant aboard an autonomous vehicle).

The biometric sensor 210 may be connected to the processor 214 and may transfer a measured biometric signal to the processor 214. The biometric sensor 210 may include at least some of the components and/or functions of the sensor module 176 illustrated in FIG. 1. The processor 214 may analyze a biometric signal from the biometric sensor 210 so as to measure biometric information such as the user's heart rate, stress, and blood oxygen saturation level (SpO2).

For example, the biometric sensor 210 may include a photosensor capable of sensing reflected light, which is light emitted by a light-emitting element (for example, an LED) and then reflected by an external object (for example, the user's body), with a light-emitting element (for example, a photodiode), and measuring biometric information based on the reflected light sensed with the light-receiving element. The photosensor may be, for example, a photoplethysmography (PPG) sensor, but is not limited thereto. As another example, the biometric sensor 210 may include at least one of a heart rate sensor, a conductivity sensor, an ECG sensor, a body temperature sensor, a respiration rate sensor, a pupil recognition sensor, or a fatigue recognition sensor.

According to an embodiment, the biometric sensor 210 may further include a motion sensor 211. The motion sensor 211 may provide the processor 214 with a motion signal generated as a result of sensing a movement of the electronic device 201. The motion sensor 211 may be implemented as various kinds of sensors capable of sensing movements of the electronic device 201, such as a gyro sensor, an acceleration sensor, and a geomagnetic sensor. The processor 214 may assess the degree of movement of the electronic device 201 based on a sensing signal from the motion sensor, and may determine the motion state (for example, a normal state, an exercising state, a sleeping state) of the electronic device 201 accordingly.

According to an embodiment, the biometric sensor 210 may be implemented as multiple sensors capable of measuring biometric information of the occupant (or the user), and may be implemented as at least one sensor module including a set of sensors.

The communication module 212 of the electronic device 201 may transmit/receive data with various external devices, for example, with an autonomous vehicle 202. The communication module may include at least some of the components and/or functions of the communication module 190 in FIG. 1.

According to an embodiment, the communication module 212 may establish communication connection to the autonomous vehicle 202, based on that the electronic device 201 is positioned inside the autonomous vehicle 202. For example, the communication module 212 may request the autonomous vehicle 202 to establish communication connection in reaction to the electronic device 201 entering the autonomous vehicle 202. As another example, the communication module 212 may receive a request for communication connection from the autonomous vehicle 202 and may form a communication link with the autonomous vehicle 202 in response thereto.

According to another embodiment, the electronic device 201 may be connected to the autonomous vehicle 202 through a communication interface (for example, a universal serial bus (USB) connection).

The memory 213 of the electronic device 201 may be electrically connected to the processor 214. The memory 213 may include at least some of the components and/or functions of the memory 130 in FIG. 1.

The memory 213 may store various instructions that may be performed by the processor 214. The instructions may include control commands related to arithmetic and logical operations, data movements, and inputs/outputs, which may be recognized by the processor 214, and may be defined on a framework stored in the memory 213.

The memory 213 may store various programs for measuring biometric information.

The processor 214 of the electronic device 201 may be operatively connected to the biometric sensor 210, the communication module 212, and the memory 213. The processor 214 may include at least some of the components and/or functions of the processor 120 illustrated in FIG. 1. In some embodiments, the processor 214 may be included in a sensor hub (or a sensor module) configured to sense sensing signals from multiple sensors mounted in an electronic device and to control the sensors.

The processor 214 may be configured to perform operations defined by instructions stored in the memory 213. For example, operations of the processor 214 may be performed by loading instructions stored in the memory 213.

The processor 214 may measure (or estimate/acquire) biometric information based on a biometric signal received from the biometric sensor 210. The processor 214 may measure biometric information, such as the occupant's heart rate, stress, ECG, blood oxygen saturation level (SpO2), blood flow rate, blood glucose, degree of arteriosclerosis, vascular elasticity, and blood pressure, based on features (or feature points) of the biometric signal.

The processor 214 may measure physical activity information based on a biometric signal acquired from the biometric sensor 210 and a motion signal acquired from the motion sensor 211. The processor 214 may measure physical activity information (or a physical activity pattern), such as the occupant's normal state, sleeping state, exercising state, and concentration state, based on features of the biometric signal and the motion signal.

The processor 214 may identify at least one of the occupant's emotional state or physical activity state, based on the biometric information and the physical activity information, thereby determining the occupant's mental/physical state.

The processor 214 may sense a change in the occupant's mental/physical state. For example, the processor 214 may assess whether the occupant's mental/physical state deviates from a configured standard range or changes by a configured value or more (for example, an abrupt change). For example, the processor 214 may sense a transition from a mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, the occupant is nervous, or the occupant is asleep), based on at least one of the biometric information or the physical activity information. To the contrary, the processor 214 may sense a transition from the occupant's mentally/physically unstable state to a mentally/physically stable state.

In some embodiments, when the biometric information and the physical activity information are numeric alized and expressed accordingly, the processor 214 may identify a standard range corresponding to a mentally/physically stable state and, if a numericalized value has increased beyond a reference value configured in a standard range (for example, a range designated as a mentally/physically stable state), the processor 214 may confirm a transition from the mentally/physically stable state to a mentally/physically unstable state. As an example, if a biometric signal indicates a stress value measured in the standard range, and if the measured stress value increases beyond a predetermined reference value in the standard range, the processor 214 may confirm a transition from the occupant's mentally/physically stable state to a mentally/physically unstable state. Alternatively, if the measured heart rate or blood pressure value is in the standard range, and if the measured value increases beyond the predetermined reference value, the processor 214 may confirm a transition from the occupant's mentally/physically stable state to a mentally/physically unstable state.

According to some embodiments, when biometric information is expressed as emotional information, the processor 214 may identify emotional information included in a positive range and emotional information included in a negative range, and may determine that the occupant's mental/physical state has changed from a stable state to an unstable state, based on a transition of the occupant's emotional state from the positive range to the negative range. To the contrary, the processor 214 may determine that the occupant's mental/physical state has changed from an unstable state to a stable state, based on a transition of the occupant's emotional state from the negative range to the positive range.

According to some embodiments, the processor 214 may analyze at least one of a biorhythm and biological activity information or may confirm a transition of the user from a normal state to a sleepy state (or an attention-deficit state). According to some embodiments, the processor 214 may analyze eyeball biometric information (for example, eye blinking information) based on information acquired from an image sensor (not illustrated) for photographing the occupant, thereby confirming a transition of the user from a normal state to a sleepy state (or an attention-deficit state).

The processor 214 may react to a change in the occupant's mental/physical state and may provide mental/physical state change information (for example, information indicating a transition from a stable state to an unstable state or vice versa) to the autonomous vehicle 202 through the communication module 212.

According to some embodiments, the electronic device 201 may receive a request for biometric information or mental/physical state from the autonomous vehicle 202 and may provide measured mental/physical state information (or biometric information and physical activity information) of the occupant in response to the request of the autonomous vehicle 202.

According to some embodiments, the electronic device 201 may provide the autonomous vehicle 202 with at least one of measured biometric information of the occupant, physical activity information, or mental/physical state change information in real time or periodically through the communication module 212.

According to an embodiment, the autonomous vehicle 202 may include a communication device 220, a sensor device 221, a driving device 225, and a processor 230, but is not limited thereto, and may include other versatile components (for example, a display device, an input device, an audio input/output device, a storage device, a power supply device) for an autonomous driving function or vehicle configuration. As an example, the communication device 220, the sensor device 221, and the processor 230 mounted in the autonomous vehicle 202 may be referred to as an autonomous driving control device as a whole.

The communication device 220 may transmit/receive data with an external device, for example, the electronic device 201. According to an embodiment, the communication device 220 may request communication connection to the electronic device 201, based on that the electronic device 201 is positioned inside the autonomous vehicle 202, and may form a communication link in reaction to a response of the electronic device. According to another embodiment, the communication device 220 may determine whether the electronic device 201 is within a predetermined distance from the autonomous vehicle 202, may send a request for communication connection to the electronic device 201 in reaction to the electronic device 201 being positioned within the predetermined distance, and may form a communication link in reaction to a response of the electronic device.

According to an embodiment, the communication device 220 may receive the occupant's (or user's) mental/physical state change information from the electronic device 201. According to some embodiments, the communication device 220 may receive at least one of the occupant's (or user's) biometric information, physical activity information, or mental/physical state from the electronic device 201.

According to an embodiment, the communication device 220 may receive at least one of weather information, driving environment information (for example, road situation information, surrounding area information, map information, topographic information, traffic accident information, enforcement information, attention-requiring zone information) or facility information (for example, gas station information, vehicle repair shop information, parking information) from an external device, for example, a server, but is not limited thereto.

The sensor device 221 may include sensors capable of sensing various pieces of information related to the autonomous vehicle 202.

The autonomous vehicle 202 may include, for example, at least one of an image sensor, an inertial sensor, a position sensor, an acceleration sensor, a distance sensor, a geomagnetic sensor, a humidity sensor, a gyro sensor, an air pressure sensor, a proximity sensor, an infrared sensor, a voice recognition sensor, a movement recognition sensor, a pupil recognition sensor, a degree-of-fatigue recognition sensor, a vibration sensor, a radar sensor, an environment sensor, an air flow sensor, an air temperature sensor, a barometric pressure sensor, a water temperature sensor, a throttle position sensor, a motor position sensor, an oxygen sensor, a knock sensor, an oil sensor, a fuel sensor, a tire sensor, a brake sensor, a speed sensor, an external temperature sensor, an external illuminance sensor, or a surrounding recognition sensor, but is not limited thereto.

The sensor device 221 may transfer information sensed in relation to autonomous driving to the processor 230. The sensor device 221 may acquire information regarding movements of the autonomous vehicle 202, for example, at least one of the direction in which the vehicle travels, the steering rotational angle, the traveling speed, the traveling acceleration, and traveling position information. The sensor device 221 may acquire surrounding information such as the speed of a dynamic obstacle (for example, another vehicle) near the autonomous vehicle 202, the position of the dynamic obstacle, or the distance between vehicles. The sensor device 221 may acquire at least one of road pattern information or road size information, such as the state or curvature of the currently traveled road surface.

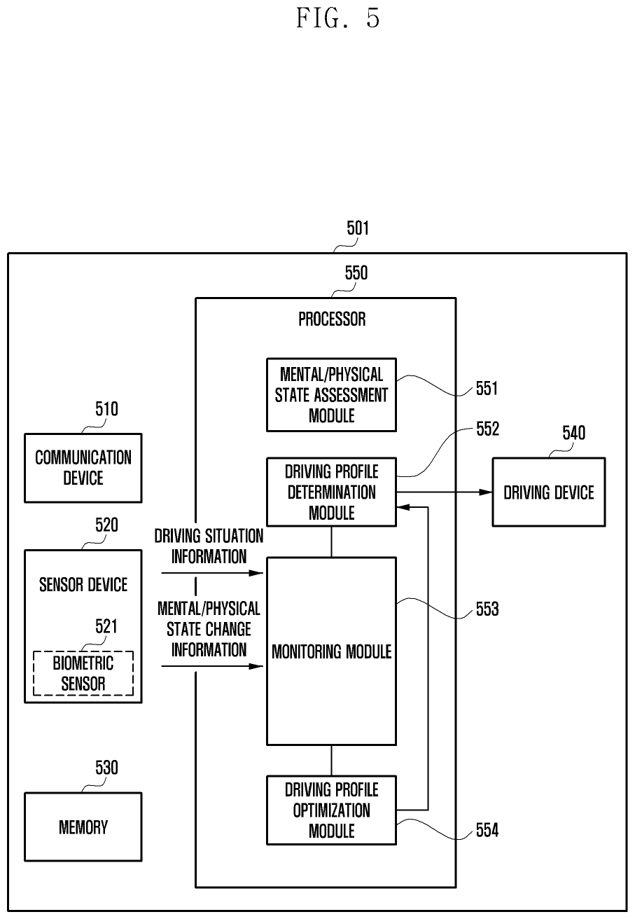

According to some embodiments, the autonomous vehicle 202 may include a biometric sensor, and a detailed example in which the autonomous vehicle 202 includes a biometric sensor will be described with reference to FIG. 5.

The driving device 225 may include various devices configured to control movements of the autonomous vehicle 202. The driving device 225 may include, for example, at least one of a navigation system, an engine output device, an accelerator control device, a brake control device, a steering wheel control device, a cooling device, a heating device, a window control device, a ventilation control device, an audio/video control device, a direction indication control device, a steering angle control device, an internal lighting control device, or a driver's seat tuning device.

The driving device 225 may operate based on a first parameter value obtained by configuring a default parameter corresponding to autonomous driving function execution determined according to an autonomous driving profile (or an autonomous driving policy).

The storage device 222 may store a path generating program, an autonomous driving function generating program, a speed profile generating profile, a collision risk calculating program, or a driving optimization program. The storage device 222 may store a program for execution of a control operation or an autonomous driving function of the autonomous vehicle 202.

The storage device 222 may store various instructions which may be performed by the processor 230. The instructions may include control commands related to arithmetic and logical operations, data movements, and inputs/outputs, which may be recognized by the processor 230, and may be defined on a framework stored in the storage device 222.

The processor 230 of the autonomous vehicle 202 may be operatively connected to the communication device 220, the sensor device 221, the storage device 222, and the driving device 225.

The processor 230 may include a driving profile determination module 231, a monitoring module 232, and a driving profile optimization module 233. The driving profile determination module 231, the monitoring module 232, and the driving profile optimization module 233 may be implemented as software (or a program) or may be implemented as separate hardware components.

According to an embodiment, the driving profile determination module 231 may determine at least one autonomous driving function according to an autonomous driving profile. For example, the driving profile determination module 231 may assess the current situation of the autonomous driving 202, may determine an autonomous driving function conforming to the autonomous driving situation, based on at least one of destination information, sensing information acquired from a sensor device, or surrounding information acquired from a communication device, and may change the autonomous driving function according to a situation change.

The autonomous driving function may include, for example, a straight road traveling function, a curved road traveling function, an evasive steering function, a forward collision prevention function, a lane departure prevention function, a function for maintaining the distance from the preceding vehicle, a function for traveling along entry/exit lanes, a rear collision prevention function, a lane change function, or a speed adjusting function, but is not limited thereto.

The driving profile determination module 231 may control a parameter corresponding to the driving device 225 configured to control movements of the autonomous vehicle, when the vehicle is driven by the autonomous driving function, at a configured default value (for example, first parameter value). For example, the parameter may include at least one of the rate of traveling acceleration, the rate of traveling deceleration, a curve entry speed or rotational speed, a curve entry angle or rotational angle, a braking distance, a collision distance, a path pattern, a brake sensitivity, a steering sensitivity, a maximum speed, a g-force, a seat adjustment value, a suspension frequency, and a steering angle.

For example, a parameter corresponding to a straight traveling function may be the rate of traveling acceleration, and 90 km/h may be configured as the default value (for example, first parameter value) of the rate of traveling acceleration during straight traveling. The driving profile determination module 231 may control the driving device 225 such that the vehicle travels at a speed of 90 km/h by using the straight traveling function.

The autonomous driving function may be varied according to the traveled road and the driving situation. The parameter may differ for each autonomous driving function type. The default value of the parameter corresponding to each autonomous driving function type may also differ.

According to some embodiments, the autonomous driving profile may be generated by an autonomous driving service server (not illustrated), and may be provided to the autonomous vehicle through a communication link connected to the service server. In this case, the driving profile determination module 231 may be omitted.

According to some embodiments, the driving profile determination module 231 may identify the occupant based on the occupant's biometric information, and may generate an autonomous driving profile customized for each occupant.

The monitoring module 232 may acquire at least one of driving situation information and mental/physical situation information, thereby monitoring at least one of the autonomous driving function, the driving situation, and a change in the occupant's mental/physical state.

The monitoring module 232 may monitor whether the driving situation changes or whether the user's mental/physical state changes, and may provide the monitoring result to the driving profile optimization module 233. For example, the monitoring module 232 may monitor a change in driving situation, based on at least one of traveled road change information, surrounding traffic situation change information, accident occurrence information, obstacle occurrence information, weather change information, emergency braking occurrence information, manual brake manipulation occurrence information, road change information, or manual steering manipulation occurrence result information, and may provide the same to the driving profile optimization module 233.

According to an embodiment, the monitoring module 232 may receive mental/physical state change information, which occurs when the occupant's mental/physical state deviates from a configured standard range or changes more than a configured value (for example, an abrupt change), from the electronic device 201 connected to the autonomous vehicle 202. For example, the monitoring module 232 may receive information corresponding to a transition from the occupant's mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, the occupant is nervous, or the occupant is asleep), from the electronic device 201. To the contrary, the processor 230 may receive information corresponding to a transition from the occupant's mentally/physically unstable state to a mentally/physically stable state.

The monitoring module 232 may react to a timepoint at which the occupant's mental/physical state has transitioned from a stable state to an unstable state or from the unstable state to the stable state, and may provide transfer (or notification) indicating the mental/physical state change to the driving profile optimization module 233.

According to some embodiments, the monitoring module 232 may acquire biometric information. For example, the monitoring module 232 may receive the occupant's biometric information from the electronic device 201 connected to the autonomous vehicle 202 or may receive the occupant's mental/physical state, and may monitor a mental/physical state change based thereon. In this case, the monitoring module 232 may sense a transition of the occupant's mental/physical state from a stable state to an unstable state or from the unstable state to the stable state.

The monitoring module 232 may monitor the traveled road so as to support a traveled path change according to the traveled road. The monitoring module 232 may monitor the surrounding traffic situation so as to support a traveled path change according to the traffic situation.

The driving profile optimization module 233 may analyze the driving situation in reaction to a change in the user's mental/physical state and may identify the autonomous driving function which is being executed at the timepoint of the mental/physical state change. The driving profile optimization module 233 may identify parameters of the driving device related to the identified autonomous driving function, and may adjust a first parameter value configured as the default with regard to the parameters to a second parameter value. The driving profile optimization module 233 may make an addition/subtraction with reference to the first parameter value configured as the default, thereby adjusting the same to the second parameter value. For example, if the first parameter value of traveling speed is 80 km/h when traveling along a straight road, the driving profile optimization module 233 may reduce the speed by −5 km/h, for example, with reference to 80 km/h, thereby adjusting the same to a second parameter value (for example, 75 km/h). As another example, the adjustment range may be added/subtracted by 1 km/h.

The driving profile optimization module 233 may change a value (for example, first parameter value) configured for a parameter corresponding to the driving device 225, thereby controlling vehicle movements (or the degree of autonomous driving function).

According to another embodiment, the driving profile optimization module 233 may receive driving situation information from the monitoring module 232 and may analyze the driving situation information. The driving profile optimization module 233 may determine whether a traveled path change condition is detected according to the driving situation and may change the traveled path or adjust a parameter in reaction to detection of the traveled path change condition. For example, the driving profile optimization module 233 may determine a second parameter value (for example, an increased value or a decreased value) for changing (or adjusting) the parameter from a first parameter value configured as a default, and may apply the second parameter value in real time, thereby adjusting the operation of the driving device 225 (in other words, movement of the vehicle).

The driving profile optimization module 233 may respond to a mental/physical state or a driving situation change, thereby confirming whether the occupant's mental/physical state transitions from an unstable state to a stable state after or while adjusting the parameter. The driving profile optimization module 233 may repeat a process of readjusting (for example, a third parameter value increased or decreased from the second parameter value) the degree of parameter if the occupant's mental/physical state remains unstable and readjusting the same until the occupant's mental/physical state becomes stable.

The driving profile optimization module 233 may react to a transition of the occupant's mental/physical state from an unstable state to a stable state, and may transfer (or feedback) the second parameter value when occupant's mental/physical state becomes stable to the driving profile determination module 231 so as to be applied to the autonomous driving profile (in other words, so as to be updated or recorded to a parameter configuration value of the autonomous driving function corresponding to the mental/physical state change).

The driving profile optimization module 233 may transfer situation information at a timepoint at which the occupant's mental/physical state has become unstable (for example, situation information indicating that the mental/physical state remains unstable when entering a curved road at 80 km/h or higher) and an adjustment value (for example, second parameter value) corresponding to a timepoint at which the occupant's mental/physical state transitions from an unstable state to a stable state, to the driving profile determination module 231. The driving profile determination module 231 may update an unpredicted pattern that the vehicle has failed to predict and an adjustment value, thereby renewing the profile to a personally customized profile, such that the same situation is not repeated in connection with autonomous driving.

An autonomous driving control device according to various embodiments (for example, autonomous driving control device 202) may include a communication module (for example, communication device 220) and a processor 230 operatively connected to the communication module. The processor 230 may be configured to connect to an electronic device (for example, electronic device 201) of an occupant positioned inside an autonomous vehicle through the communication module, control a parameter related to a driving device configured to control movements of the autonomous vehicle at a first parameter value when the autonomous vehicle is driven by at least one autonomous driving function, identify a transition of the occupant's mental/physical state from a stable state to an unstable state, based on biometric information transferred from the electronic device, while being driven by the autonomous driving function, and adjust the first parameter value to a second parameter value in reaction to a transition of the occupant's mental/physical state from a stable state to an unstable state.

According to an embodiment, the processor 230 may be further configured to adjust the first parameter value to the second parameter value such that the occupant's mental/physical state becomes stable, in reaction to receiving first information indicating a transition of the occupant's mental/physical state from a stable state to an unstable state from the electronic device.

According to an embodiment, the processor 230 may control communication connection to be established with the electronic device through the communication module according to a condition that the occupant's electronic device is positioned inside the autonomous vehicle, a condition that the electronic device is positioned within a preconfigured distance from the autonomous vehicle, or the occupant's request, and may receive the occupant's biometric information from the electronic device, based on communication connection to the electronic device.

According to an embodiment, the processor 230 may be configured to readjust the second parameter value to a third parameter value until second information indicating that the occupant's mental/physical state has become stable is received from the electronic device after adjusting the first parameter value to the second parameter value.

According to an embodiment, the processor 230 may be further configured to request an electronic device to provide the occupant's physical activity pattern, and compare the physical activity pattern received from the electronic device to a previously captured physical activity pattern of the occupant so as to determine whether the occupant's mental/physical state is valid.

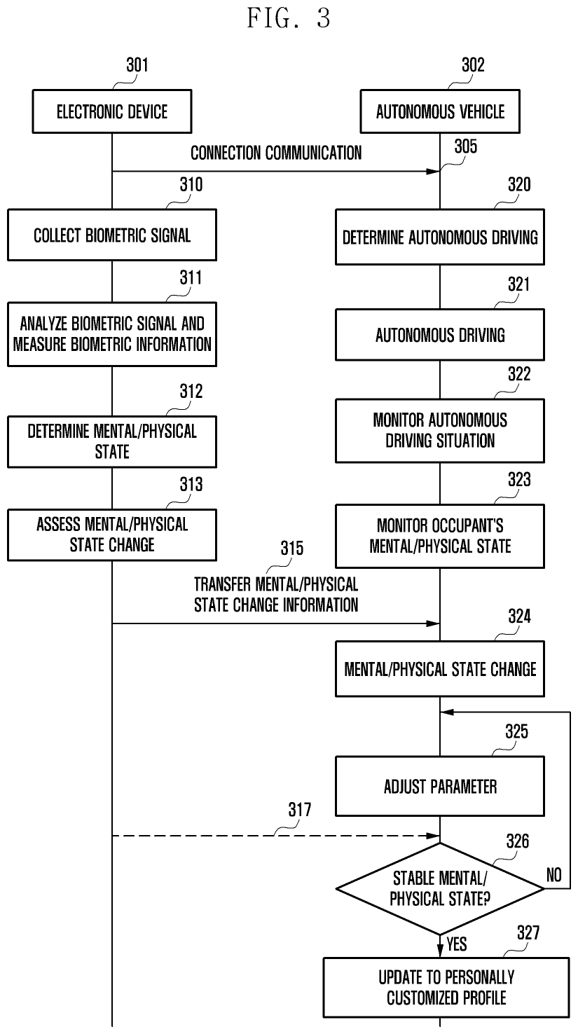

FIG. 3 illustrates an electronic device and a method for improving an autonomous driving profile of an autonomous driving vehicle according to various embodiments.

Referring to FIG. 3, according to an embodiment, the electronic device 301 (for example, the electronic device 101 in FIG. 1, the electronic device 201 in FIG. 2) may establish communication connection to the autonomous vehicle 302 (for example, the autonomous vehicle 202 in FIG. 2) in operation 310.

According to an embodiment, the autonomous vehicle 302 may request the electronic device 301 to establish a communication connection in reaction to the electronic device 301 approaching within a preconfigured distance or entering the autonomous vehicle 302, and may form a communication link according to a connection response of the electronic device 301.

According to some embodiments, the electronic device 301 may request the autonomous vehicle 302 to establish communication connection in reaction to the autonomous vehicle 302 being positioned within a preconfigured distance, and may form a communication link according to a connection response of the autonomous vehicle 302. According to some embodiments, the autonomous vehicle 302 and the electronic device 301 may be connected in a wired manner (for example, cable or USB connection).

In operation 310, the electronic device 301 may collect the occupant's (or user's) biometric signal, based on connection to the autonomous vehicle 302. For example, the electronic device 301 may execute a biometric measurement process so as to acquire a biometric signal from a biometric sensor.

In operation 311, the electronic device 301 may analyze the biometric signal so as to measure biometric information. For example, the electronic device 301 may analyze feature points of the biometric signal so as to measure biometric information, such as the occupant's heart rate, stress, ECG, blood oxygen saturation level (SpO2), blood flow rate, blood glucose, degree of arteriosclerosis, vascular elasticity, or blood pressure. Additionally, the electronic device 301 may analyze feature points of the biometric signal and a motion signal so as to measure physical activity information (or a physical activity pattern), such as the occupant's normal state, sleeping state, exercising state, or concentration state.

In operation 312, the electronic device 301 may determine the occupant's mental/physical state based on at least one of the biometric information and the physical activity information.

In operation 313, the electronic device 301 may confirm whether the occupant's mental/physical state deviates from a configured standard range or changes beyond a configured value (for example, abruptly changes).

For example, the electronic device 301 may sense a transition from a mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, or the occupant is nervous), based on at least one of the biometric information or the physical activity information. To the contrary, the electronic device 301 may sense a transition of the occupant's mental/physical state from an unstable state to a stable state.

As an example, the electronic device 301 may confirm a transition from a stable state to an unstable state if the measured stress value has increased beyond a predetermined reference value in the standard range. The electronic device 301 may confirm a transition from a stable state to an unstable state if the measured heart rate or blood pressure value has increased beyond a predetermined reference value in the standard range.

As another example, the electronic device 301 may confirm a transition from a stable state to an unstable state in the case of a transition from an emotional state included in a positive range to an emotional state included in a negative range.

As another example, the electronic device 301 may confirm a transition from a stable state to an unstable state if the user has transitioned from a normal state to a sleepy state (or an attention-deficit state), based on biorhythm, activity amount information, or eyeball biometric information.

In operation 315, the electronic device 301 may transfer mental/physical state change information to the autonomous vehicle 302. The electronic device 301 may transfer information indicating a transition of the occupant's mental/physical state from a stable state to an unstable state or vice versa.

According to some embodiments, while being connected to the autonomous vehicle 302, the electronic device 301 may provide the autonomous vehicle 302 with the occupant's biometric information and physical activity information in real time or periodically, or may provide the autonomous vehicle 302 with mental/physical state information.

The autonomous vehicle 302 may determine an autonomous driving profile (or an autonomous driving policy) and may determine at least one autonomous driving function according to the autonomous driving profile in operation 320 independently or in parallel to operations 310 to 315. For example, the autonomous vehicle 302 may determine an autonomous driving profile appropriate for the current situation, based on at least one of destination information, sensing information acquired from a sensor device, surrounding information acquired from a communication device, or a driving path, and may determine an autonomous driving function corresponding to the autonomous driving profile.

In operation 321, the autonomous vehicle 302 may execute the determined autonomous driving function, thereby controlling the vehicle movement (in other words, autonomous driving). For example, the autonomous vehicle 302 may an autonomous driving function appropriate for the current driving situation, and may determine a parameter of a driving device corresponding to execution of the autonomous driving function. The autonomous vehicle 302 may operate the vehicle driving device with a first parameter value, based on the parameter, thereby controlling the vehicle movement.

In operation 322, the autonomous vehicle 302 may monitor the autonomous driving function and the driving situation when the autonomous driving function is executed.

According to an embodiment, the autonomous vehicle 302 may analyze whether an autonomous driving situation change condition is detected based on driving situation information. For example, the autonomous vehicle may monitor the occurrence of obstacles along the traveled path and may control the autonomous driving path to be changed to avoid obstacles.

The autonomous vehicle 302 may monitor a change in the occupant's mental/physical state in an independent or parallel manner, in operation 323. According to some embodiments, operation 323 may be omitted.

The autonomous vehicle 302 may receive the occupant's mental/physical state change information by means of operation 315 of the electronic device 301.

In operation 324, the autonomous vehicle 302 may identify the occurrence of a situation (for example, an unpredicted pattern) which changes the occupant's mental/physical state, or which changes the autonomous driving situation. For example, upon sensing an obstacle that has failed to be predicted in advance during autonomous driving, the autonomous vehicle 302 may identify the occurrence of a mental/physical state change condition or a situation that changes the driving situation.

In operation 325, the autonomous vehicle 302 may react to a change in the occupant's mental/physical state or a change in autonomous driving, may analyze the driving situation, and may adjust (fine-tune) the parameter that is currently driven with a first parameter value to a second parameter value.

As an example, the autonomous vehicle 302 may analyze the driving situation based on driving situation information (for example, road information, traffic information, obstacles, road surface situation information), thereby identifying the autonomous driving function that is being executed at the timepoint of change of the mental/physical state. The autonomous vehicle 302 may change a first parameter value configured as a default for a parameter corresponding to a driving device to a second parameter value, in order to adjust the movement of the autonomous vehicle, and may adjust the operation of the driving device with the second parameter value. The autonomous vehicle 302 may adjust the distance from the preceding vehicle so as to increase or decrease during the autonomous driving function, or adjust the current traveling speed to increase or decrease.

In operation 326, the autonomous vehicle 302 may determine whether the occupant's mental/physical state transitions from an unstable state to a stable state.

As an example, the autonomous vehicle 302 may receive information indicating a transition of the occupant's mental/physical state from an unstable state to a stable state as in operation 317 of the electronic device. According to some embodiments, the autonomous vehicle 302 may determine a transition to the stable state, based on biometric information transferred from the electronic device.

If the occupant's mental/physical state is unstable, the autonomous vehicle 302 may return to operation 324, may readjust the parameter (for example, adjust the same to a third parameter), and may control the movement of the autonomous vehicle.

In operation 327, the autonomous vehicle 302 may react to a transition of the occupant's mental/physical state from an unstable state to a stable state and may change (or record) the same such that a second parameter value adjusted in the autonomous driving profile is reflected, thereby updating (or renewing) the same to a personally customized profile.

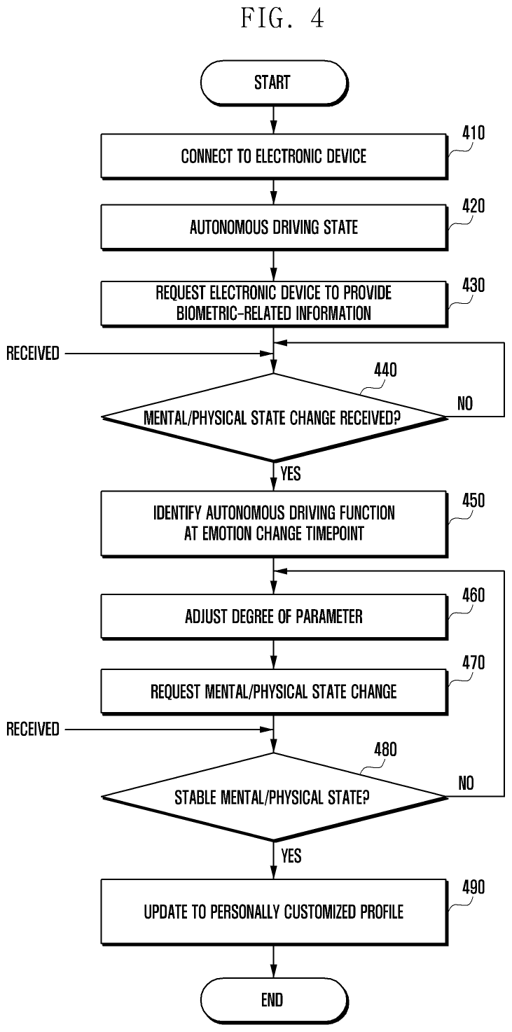

FIG. 4 illustrates a method for improving an autonomous driving profile of an autonomous vehicle according to various embodiments.

Referring to FIG. 4, according to an embodiment, the autonomous vehicle (for example, the autonomous vehicle 202 in FIG. 2) may be connected to an electronic device (for example, the electronic device 101 in FIG. 1 or the electronic device 201 in FIG. 2) and may support a function of requesting the electronic device to provide the occupant′ (or user's) biometric information, mental/physical state information, or mental/physical state change information, based on the electronic device being positioned inside the autonomous vehicle.

According to an embodiment, the processor 230 of the autonomous vehicle 202 may be connected to the electronic device in operation 410.

In operation 420, the processor 230 may control a parameter corresponding to a driving device, when traveling by an autonomous driving function according to an autonomous driving profile, with a first parameter value, thereby controlling the movement of the autonomous vehicle 202.

In operation 430, the processor 230 may request the electronic device to provide information related to a biometric sensor in order to monitor the occupant's mental/physical state when traveling with the autonomous driving function.

As an example, the processor 230 may request the electronic device to provide information indicating whether the occupant's mental/physical state becomes unstable.

According to some embodiments, the processor 230 may request original data of the occupant's biometric information or mental/physical state.

In operation 440, the processor 230 may determine whether mental/physical state change information is received from the electronic device. If mental/physical state change information is received, the processor 230 may proceed to operation 450 and, if no mental/physical state change information is received, the processor 230 may stand by until mental/physical state change information is received.

According to an embodiment, the processor 230 may receive, from the electronic device, information indicating a transition from the occupant's mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, the occupant is nervous, or the occupant is asleep).

In operation 450, the processor 230 may react to a condition that the occupant's mental/physical state change information is received from the electronic device, and may analyze the driving situation, thereby identifying an autonomous driving function that corresponds to the change in the mental/physical state while autonomous driving is currently executed.

In operation 460, the processor 230 may adjust (fine-tune) a first parameter value of the identified autonomous driving function to a second parameter value.

For example, the processor 230 may determine a first parameter value configured as a default with regard to identified parameters, and may determine a second parameter value (for example, an increased value or a decreased value) for adjusting the same with reference to the first parameter value. The processor 230 may change the operation of the driving device to the second parameter value, thereby tuning vehicle operation control (or the degree of the autonomous driving function). For example, the processor 230 may adjust a parameter of the autonomous driving function, for example, the distance from the preceding vehicle, so as to increase or decrease, or adjust the current traveling speed so as to increase or decrease, thereby tuning the vehicle movement.

In operation 470, the processor 230 may request the electronic device to provide mental/physical state change information while the vehicle operation is adjusted. For example, the processor 230 may request the electronic device to provide information indicating whether the occupant's mental/physical state becomes stable. According to some embodiments, the processor 230 may request original data of the occupant's biometric information or mental/physical state.

In operation 480, the processor 230 may determine whether the occupant's mental/physical state becomes stable.

According to an embodiment, the processor 230 may receive information indicating a transition of the occupant's mental/physical state from an unstable state to a stable state from the electronic device.

According to some embodiments, when the electronic device is requested to provide original data of the occupant's biometric information or mental/physical state information, the processor 230 may analyze the original data transferred from the electronic device, thereby identifying the timepoint of a transition of the mental/physical state from an unstable state to a stable state.

If the occupant's mental/physical state is unstable, the processor 230 may return to operation 460 and readjust the parameter (for example, adjust the same to a third parameter value) and may tune the movement of the autonomous vehicle.

In operation 490, the processor 230 may react to a transition of the occupant's mental/physical state from an unstable state to a stable state, may identify a second parameter value that makes the occupant's mental/physical state stable, and may change (or record) the second parameter value to be reflected in the autonomous driving profile, thereby making a personally customized update (or renewal).

FIG. 5 illustrates the configuration of an autonomous vehicle according to various embodiments. Detailed descriptions of components illustrated in FIG. 5, which have substantially identical functions as those of components in FIG. 2, may be omitted herein.

Referring to FIG. 5, an autonomous vehicle 501 according to an embodiment may include a communication device 510, a sensor device 520, a memory 530, a driving device 540, and a processor 550, but is not limited thereto, and may include other versatile components (for example, a display device, an input device, an audio input/output device, a storage device, a power supply device) for an autonomous driving function or vehicle configuration.

As an example, at least some components of the autonomous vehicle 501 may be referred to as an autonomous driving control device as a whole.

The communication device 510 may transmit/receive data with various external devices, for example, an autonomous driving service server. The communication device 510 may receive at least one of weather information, driving environment information (for example, road situation information, surrounding area information, map information, topographic information, traffic accident information, enforcement information, attention-requiring zone information) or facility information (for example, gas station information, vehicle repair shop information, parking information) from an autonomous driving service server, a weather server, a road traffic server, or a navigation server, but is not limited thereto.

The sensor device 520 may include sensors capable of sensing various pieces of information related to the autonomous vehicle 501. The sensor device 520 may include, for example, at least one of an image sensor, an inertial sensor, a position sensor, an acceleration sensor, a distance sensor, a geomagnetic sensor, a humidity sensor, a gyro sensor, an air pressure sensor, a proximity sensor, an infrared sensor, a voice recognition sensor, a movement recognition sensor, a pupil recognition sensor, a degree-of-fatigue recognition sensor, a vibration sensor, a radar sensor, an environment sensor, an air flow sensor, an air temperature sensor, a barometric pressure sensor, a water temperature sensor, a throttle position sensor, a motor position sensor, an oxygen sensor, a knock sensor, an oil sensor, a fuel sensor, a tire sensor, a brake sensor, a speed sensor, an external temperature sensor, an external illuminance sensor, or a surrounding recognition sensor, but is not limited thereto.

The sensor device 520 may include a biometric sensor 521. The biometric sensor 521 may include a photosensor capable of sensing reflected light, which is light emitted by a light-emitting element (for example, an LED) and then reflected by an external object (for example, the user's body), with a light-emitting element (for example, a photodiode), and measuring biometric information based on the reflected light sensed with the light-receiving element. The photosensor may be, for example, a photoplethysmography (PPG) sensor, but is not limited thereto. As another example, the biometric sensor 521 may include at least one of a heart rate sensor, a conductivity sensor, an ECG sensor, a body temperature sensor, a respiration rate sensor, a pupil recognition sensor, or a fatigue recognition sensor.

The sensor device 520 may transfer information sensed in relation to autonomous driving and a biometric signal measured by the biometric sensor 521 to the processor 550.

For example, the sensor device 520 may acquire information regarding movements of the autonomous vehicle 501, for example, at least one of the direction in which the vehicle travels, the steering rotational angle, the traveling speed, the traveling acceleration, or traveling position information. The sensor device 520 may acquire surrounding information, such as the speed of a dynamic obstacle (for example, another vehicle) near the autonomous vehicle 501, the position of the dynamic obstacle, or the distance between vehicles, and may transfer the same to the processor 550. The sensor device 520 may acquire at least one of road pattern information or road size information, such as the state or curvature of the currently traveled road surface, and may transfer the same to the processor 550. The sensor device 520 may acquire a biometric signal of an occupant positioned inside the vehicle and may transfer the same to the processor 550.

The memory 530 may store various instructions which may be performed by the processor 550. The instructions may include control commands related to arithmetic and logical operations, data movements, and inputs/outputs, which may be recognized by the processor 550, and may be defined on a framework stored in the memory 530.

The memory 530 may store a path generating program, an autonomous driving function generating program, a speed profile generating profile, a collision risk calculating program, or a driving optimization program. The memory 530 may store a program for execution of a control operation or an autonomous driving function of the autonomous vehicle 501.

The driving device 540 may include devices configured to control at least one autonomous driving function of the autonomous vehicle 501. The driving device 540 may include, for example, at least one of a navigation system, an engine output device, an accelerator control device, a brake control device, a steering wheel control device, a cooling device, a heating device, a window control device, a ventilation control device, an audio/video control device, a direction indication control device, a steering angle control device, an internal lighting control device, or a driver's seat tuning device. The parameter may include at least one of the rate of traveling acceleration, the rate of traveling deceleration, a curve entry speed or rotational speed, a curve entry angle or rotational angle, a braking distance, a collision distance, a brake sensitivity, a steering sensitivity, a maximum speed, a g-force, a seat adjustment value, a suspension frequency, or a steering angle. The driving device 540 may be operated based on a first parameter value configured as a default in the parameter.

The processor 550 may be operatively connected to the communication device 510, the sensor device 520, the memory 530, and the driving device 540.

The processor 550 may include a mental/physical state assessment module 551, a driving profile determination module 552, a monitoring module 553, and a driving profile optimization module 554. The mental/physical state assessment module 551, the driving profile determination module 552, the monitoring module 553, and the driving profile optimization module 554 may be implemented as software (or a program) or may be implemented as separate hardware components.

The processor 550 may generate an autonomous driving profile through the driving profile determination module 552. The processor 550 may measure biometric information or physical activity information through the mental/physical state assessment module 551, may confirm whether the occupant's mental/physical state is changed, and may provide the monitoring module 553 with the timepoint at which occupant's mental/physical state is changed or information regarding the change. The processor 550 may identify driving situation change information and the occupant's mental/physical state change information through the monitoring module 553. The processor 550 may react to a driving situation change or the occupant's mental/physical state through the driving profile optimization module 554, thereby analyzing the change and may adjust (fine-tune) the parameter that controls the movement of the vehicle until the occupant's mental/physical state becomes stable. As an example, the processor 550 may identify the autonomous driving function that corresponds to change, may adjust the parameter from a first parameter value configured as a default to a second parameter value until the occupant's mental/physical state becomes stable, and may record and configure the same, thereby updating (or renewing) the profile to a personally customized profile.

The mental/physical state assessment module 551 may measure biometric information and physical activity information, based on sensor information, thereby determining the occupant's mental/physical state. The mental/physical state assessment module 551 may measure biometric information, such as the occupant's heart rate, stress, ECG, blood oxygen saturation level (SpO2), blood flow rate, blood glucose, degree of arteriosclerosis, vascular elasticity, or blood pressure, based on features (or feature points) of biometric signals.

The mental/physical state assessment module 551 may identify the occupant's emotional state or physical activity state and may confirm whether the emotional state or physical activity state deviates from a configured standard range or changes (for example, abruptly changes) beyond a configured value.

The mental/physical state assessment module 551 may assess a transition from a mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, the occupant is nervous, or the occupant is asleep). To the contrary, the mental/physical state assessment module 551 may assess a transition from the occupant's mentally/physically unstable state to a mentally/physically stable state.

As an example, when biometric information is numericalized and expressed accordingly, the mental/physical state assessment module 551 may identify a standard range corresponding to a mentally/physically stable state and, if the occupant's biometric measurement (for example, stress value, blood pressure value, heart rate value) has increased beyond a reference value configured in the standard range, may confirm a transition from a mentally/physically stable state to a mentally/physically unstable state.

As another example, when biometric information is expressed as emotional information, the mental/physical state assessment module 551 may identify emotional information included in a positive range and emotional information included in a negative range, and may determine that the occupant's mental state has changed from the positive range to the negative range.

The mental/physical state assessment module 551 may confirm a transition from a stable state to an unstable state if the user has transitioned from a normal state to a sleepy state (or an attention-deficit state), based on the occupant's biorhythm, activity amount information, or eyeball biometric information.

The mental/physical state assessment module 551 may react to the occupant's transition from a stable state to an unstable state, thereby transferring (or guiding) information to the monitoring module to inform that the mental/physical state has become unstable.

According to another embodiment, mental/physical state assessment module 551 may confirm a transition from a biometrically unstable state to a stable state and may transfer (or guide) information to the monitoring module to inform that the mental/physical state has become stable, in reaction thereto.

The driving profile determination module 552 may determine an autonomous driving profile based on at least one of destination information, sensing information acquired from a sensor device, or surrounding information acquired from a communication device, or traveled path information.

The driving profile determination module 552 may generate an autonomous driving profile appropriate for the current situation, based on a path of traveling to the destination. The autonomous driving profile may refer to a control profile for activating a driving device included in the vehicle in order to execute an autonomous driving function. The autonomous driving function may include, for example, a straight road traveling function, a curved road traveling function, an evasive steering function, a forward collision prevention function, a lane departure prevention function, a function for maintaining the distance from the preceding vehicle, a function for traveling along entry/exit lanes, a rear collision prevention function, a lane change function, or a speed adjusting function, but is not limited thereto.

The driving profile determination module 552 may control a parameter for driving a driving device or an autonomous driving function to be executed according to the generated autonomous driving profile. The driving profile determination module 552 operate the driving device with a first parameter configured as a default in the parameter, thereby controlling the vehicle movement.

For example, the parameter may include at least one of the rate of traveling acceleration, the rate of traveling deceleration, a curve entry speed or rotational speed, a curve entry angle or rotational angle, a braking distance, a collision distance, a path pattern, a brake sensitivity, a steering sensitivity, a maximum speed, a g-force, a seat adjustment value, a suspension frequency, and a steering angle.

The autonomous driving profile may execute an autonomous driving function which is varied according to the traveled road and the driving situation, and the parameter and the default value configured in the parameter may be configured under different conditions with regard to each autonomous driving function.

According to some embodiments, the autonomous driving profile may be generated by an autonomous driving service server (not illustrated), and may be provided to the autonomous vehicle through a communication link connected to the autonomous driving service server. In this case, the driving profile determination module 552 may be omitted.

According to some embodiments, the driving profile determination module 552 may identify the occupant based on the occupant's biometric information, and may generate an autonomous driving profile customized for each occupant.

The monitoring module 553 may acquire driving situation information and mental/physical situation information, thereby monitoring the autonomous driving function, the driving situation, and a change in the occupant's mental/physical state.

The monitoring module 553 may monitor whether the driving situation changes or whether the user's mental/physical state changes, and may provide the monitoring result to the driving profile optimization module 554. For example, the monitoring module 553 may monitor a change in driving situation, based on at least one of traveled road change information, surrounding traffic situation change information, accident occurrence information, obstacle occurrence information, weather change information, emergency braking occurrence information, manual brake manipulation occurrence information, road change information, or manual steering manipulation occurrence result information, and may provide the same to the driving profile optimization module 554.

The monitoring module 553 may identify that the occupant's mental/physical state has become unstable by means of the mental/physical state assessment module 551, and may provide the same to the driving profile optimization module 554. The monitoring module 553 may identify that the occupant's mental/physical state transitioned from an unstable state to a stable state by means of the mental/physical state assessment module 551, and may provide the same to the driving profile optimization module 554.

According to an embodiment, the driving profile optimization module 554 may identify an autonomous driving function (for example, a curved road traveling function) that is being executed at the timepoint of transition. The driving profile optimization module 554 may identify parameters during autonomous driving and may adjust the identified parameters. The driving profile optimization module 554 may increase/decrease the parameter from a first parameter value configured as a default, thereby adjusting the second parameter value. For example, if the first parameter value of traveling speed is 80 km/h when traveling along a straight road, the driving profile optimization module 554 may increase/decrease the same to a second parameter value by +/−5 km/h or 1 km/h, for example, with reference to 80 km/h. The driving profile optimization module 554 may change the operation of the driving device 540 so as to reflect the mental/physical state, thereby controlling the vehicle movement (or the degree of autonomous driving function).

According to another embodiment, the driving profile optimization module 554 may receive driving situation information from the monitoring module 553 and may analyze the driving situation information. The driving profile determination module 552 may determine whether a traveled path change condition is detected according to the driving situation and may change the traveled path or adjust the parameter from a first parameter value to a second parameter value in reaction to detection of the traveled path change condition.

The driving profile optimization module 554 may confirm whether the occupant's mental/physical state becomes stable after or while adjusting the parameter according to a mental/physical state change or driving situation change. The driving profile optimization module 554 may repeat a process of readjusting the degree of parameter (in other words, adjusting the parameter to a third parameter value increased or decreased from the second parameter value) if the occupant's mental/physical state remains unstable, and readjusting the same until the occupant's mental/physical state becomes stable.

The driving profile optimization module 554 may react to a transition of the occupant's mental/physical state from an unstable state to a stable state, and may transfer (or feedback) the second parameter value when occupant's mental/physical state becomes stable to the driving profile determination module 552 so as to be applied (or recorded) as a default configuration.

The driving profile optimization module 554 may transfer situation information corresponding to a transition of the occupant's mental/physical state from a stable state to an unstable state (for example, situation information indicating that the mental/physical state remains unstable when entering a curved road at 80 km/h or higher) and control information (for example, second parameter value) adjusted until the occupant's mental/physical state becomes stable, to the driving profile determination module 552. The driving profile determination module 552 may update the situation in which the mental/physical state has become unstable in connection with autonomous driving into an unpredicted pattern, and may update the adjusted parameter default value to a second parameter value, thereby renewing the profile to a personally customized profile.

An autonomous driving control device according to various embodiments (for example, autonomous driving control device 501) may include a sensor device (for example, 520) including a biometric sensor, and a processor 550. The processor may be configured to control a parameter related to a driving device configured to control movements of an autonomous vehicle at a first parameter value when the autonomous vehicle is driven by at least one autonomous driving function, monitor an occupant's mental/physical state, based on biometric information of the occupant positioned inside the autonomous vehicle, while the autonomous vehicle is driven by the autonomous driving function, and adjust the first parameter value to a second parameter value in reaction to a transition of the occupant's mental/physical state from a stable state to an unstable state as a result of the mental/physical state monitoring.

According to an embodiment, the processor 550 may collect biometric information from the biometric sensor and confirm a transition to the unstable state in case that the mental/physical state deviates from a standard range designated as a stable state, based on the biometric information.

According to an embodiment, the autonomous driving function may include at least one of a straight road traveling function, a curved road traveling function, an evasive steering function, a forward collision prevention function, a lane departure prevention function, a function for maintaining a distance from a preceding vehicle, an entry/exit lane traveling function, a rear collision prevention function, a lane change function, or a speed adjusting function, and the parameter may include at least one of the rate of traveling acceleration, the rate of traveling deceleration, a curve entry speed or rotational speed, a curve entry angle or rotational angle, a braking distance, a collision distance, a brake sensitivity, a steering sensitivity, a maximum speed, g-force, a seat adjustment value, a suspension frequency, or a steering angle.

According to an embodiment, the processor 550 may be configured to identify an autonomous driving function which is currently executed at a timepoint of transition of the occupant's mental/physical state to an unstable state, and adjust the parameter associated with the autonomous driving function which is currently executed at a timepoint of transition of the occupant's mental/physical state to an unstable state to the second parameter value and then update the adjusted second parameter value as a default configuration regarding the currently executed autonomous driving function.

According to an embodiment, the processor 550 may be configured to increase/decrease the parameter from the first parameter value so as to correspond to the type of the currently executed autonomous driving function, based on a transition of the occupant's mental/physical state to an unstable state, such that the parameter is adjusted to the second parameter value.

According to an embodiment, the processor 550 may be configured to operate the driving device with the second parameter value after adjustment to the second parameter value such that movements of the autonomous vehicle are controlled, and readjust the second parameter value to a third parameter value until the occupant's mental/physical state becomes stable in case that the occupant's mental/physical state remains unstable as a result of monitoring the mental/physical state.

According to an embodiment, the processor 550 may be further configured to change an autonomous driving function currently executed at a timepoint of transition of the occupant's mental/physical state to an unstable state to a different autonomous driving function, and control movements of the autonomous vehicle with a parameter value corresponding to the changed different autonomous driving function.

According to an embodiment, the processor 550 may be further configured to monitor a driving situation while the autonomous vehicle moves during autonomous driving, and may determine whether the occupant's mental/physical state is unstable at a timepoint of detection of an unpredicted pattern which causes an abrupt movement of the autonomous vehicle as a result of monitoring the driving situation.

According to an embodiment, the processor 550 may update the driving situation at a timepoint at which the occupant's mental/physical state has become unstable as the unpredicted pattern of monitoring.

According to an embodiment, the processor 550 may be further configured to request an electronic device to provide the occupant's physical activity pattern, and compare the physical activity pattern received from the electronic device to a previously captured physical activity pattern of the occupant so as to determine whether the occupant's mental/physical state is valid.

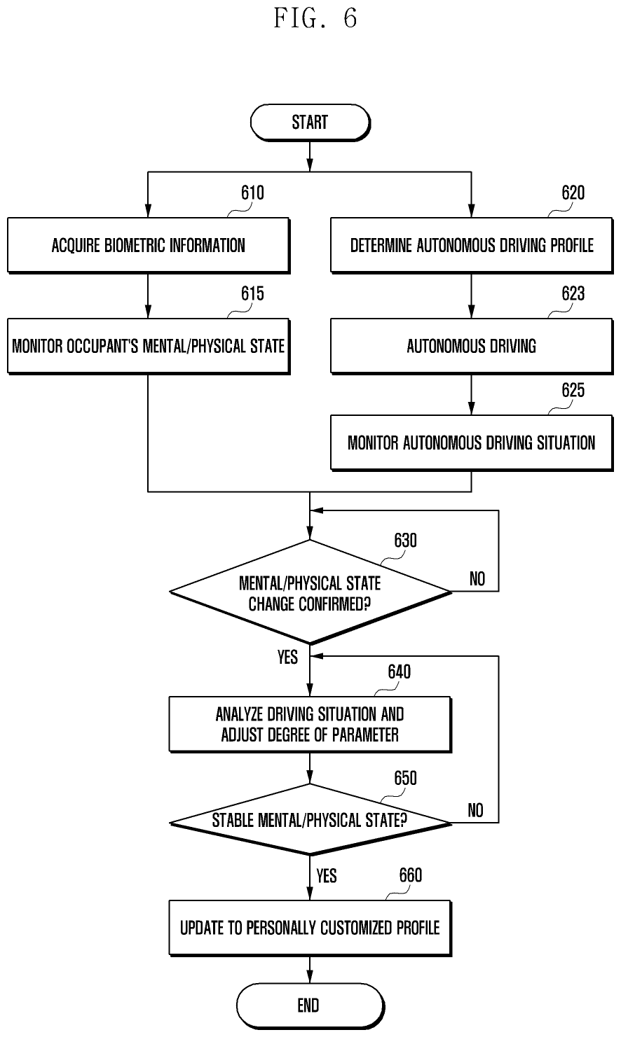

FIG. 6 illustrates a method for improving an autonomous driving profile of an autonomous vehicle according to various embodiments.

Referring to FIG. 6, according to an embodiment, the processor (for example, the processor 230 in FIG. 2 or the processor 550 in FIG. 5) of the autonomous vehicle (for example, the autonomous vehicle 202 in FIG. 2 or the autonomous vehicle 501 in FIG. 5) may acquire biometric information in operation 610.

According to an embodiment, the processor 230 or 550 may acquire a biometric signal through a biometric sensor mounted in the autonomous vehicle, and may analyze feature points of the biometric signal, thereby measuring biometric information, such as the occupant's heart rate, stress, ECG, blood oxygen saturation level (SpO2), blood flow rate, blood glucose, degree of arteriosclerosis, vascular elasticity, or blood pressure. Additionally, the processor 230 or 550 may analyze feature points of a biometric signal and a motion signal, thereby measuring physical activity information (or a physical activity pattern), such as the occupant's normal state, sleeping state, exercising state, or concentration state.

According to another embodiment, the processor 230 or 550 may communicate with an electronic device including a biometric sensor so as to acquire the occupant's biometric information from the electronic device.

In operation 615, the processor 230 or 550 may monitor the occupant's mental/physical state. According to an embodiment, the processor 230 or 550 may determine the occupant's mental/physical state based on at least one of biometric information or physical activity information. For example, the processor 230 or 550 may identify the occupant's emotional state or physical activity state based on biometric information and physical activity information, and may confirm whether the emotional state or physical activity state deviates from a configured standard range or changes (for example, abruptly changes) beyond a configured value.

The processor 230 or 550 may assess a transition from a mentally/physically stable state (for example, a state in which there is no stress, the heart rate is stable, the occupant is awake, or the blood pressure is normal) to a mentally/physically unstable state (for example, a state in which the stress has increased by a predetermined value, the heart rate has increased by a predetermined value, the blood pressure has increased by a predetermined value, the occupant is nervous, or the occupant is asleep).

According to another embodiment, the processor 230 or 550 may communicate with an electronic device including a biometric sensor so as to receive the occupant's mental/physical state information determined based on biometric information and physical activity information from the electronic device, and the processor 230 or 550 may monitor a mental/physical state change timepoint corresponding to a transition from an unstable state to a stable state.

According to an embodiment, the processor 230 or 550 may communicate with an electronic device including a biometric sensor so as to receive information indicating a transition of the mental/physical state from a stable state to an unstable state, from the electronic device.

The processor 230 or 550 may determine an autonomous driving profile for autonomous driving function execution in operation 620 independently or in parallel to operations 610 to 615. For example, the autonomous vehicle may determine an autonomous driving profile appropriate for the current situation, based on a path of traveling to the destination, based on at least one of destination information, sensing information acquired from a sensor device, surrounding information acquired from a communication device, or a driving path.

In operation 623, the processor 230 or 550 may operate the driving device with a first parameter value when traveling by the autonomous driving function, thereby controlling the movement of the autonomous vehicle.

In operation 625, the processor 230 or 550 may monitor the autonomous driving situation.

In operation 630, the processor 230 or 550 may determine whether a condition that changes the occupant's mental/physical state or the autonomous driving situation is detected.

The processor 230 or 550 may confirm that the occupant's mental/physical state has transitioned from an stable state to a unstable state, may receive information indicating a transition of the occupant's mental/physical state from an stable state to a unstable state, or may confirm that the autonomous driving function change condition is detected.

The processor 230 or 550 may analyze a change in driving situation, based on driving situation information, for example. For example, the processor 230 or 550 may monitor a change in driving situation, based on at least one of traveled road change information, surrounding traffic situation change information, accident occurrence information, obstacle occurrence information, weather change information, emergency braking occurrence information, manual brake manipulation occurrence information, road change information, or manual steering manipulation occurrence result information.

In operation 640, the processor 230 or 550 may react to a change in the occupant's mental/physical state, may analyze the driving situation, and may adjust (fine-tune) the autonomous driving parameter to a second parameter value.

The processor 230 or 550 may analyze the driving situation based on driving situation information (for example, road information, traffic information, obstacles, road surface situation information), thereby identifying the autonomous driving function that is being executed at the timepoint of change of the mental/physical state.

As an example, if a curved road autonomous driving function is currently executed, the processor 230 or 550 may identify the state in which the curved road autonomous driving function is executed, and may identify parameters of the curved road autonomous driving function, for example, rotational speed, rotational angle, and entry speed. The processor 230 or 550 may recognize an identified parameter as corresponding to the mental/physical instability, and may adjust (fine-tune) the parameter to a second parameter value. For example, the processor 230 or 550 may adjust the parameter to a second parameter value decreased from a first parameter value corresponding to the rotational speed, and may adjust the parameter to a second parameter value increased from a first parameter value corresponding to the rotational angle, thereby controlling the movement of the autonomous vehicle to be mild.

In operation 650, the processor 230 or 550 may determine whether the occupant's mental/physical state transitions from an unstable state to a stable state.

According to an embodiment, the processor 230 or 550 may determine whether the occupant's mental/physical state transitions from an unstable state to a stable state, based on biometric information.

According to another embodiment, the processor 230 or 550 may receive information indicating a transition of the occupant's mental/physical state from an unstable state to a stable state, from the electronic device.

If the occupant's mental/physical state remains unstable, the processor 230 or 550 may return to operation 630, may readjust the parameter (in other words, adjust the parameter to a third parameter value), and may again control the movement of the autonomous vehicle.

In operation 660, the processor may react to a transition of the occupant's mental/physical state from an unstable state to a stable state, and may make a change (or recording) such that an adjusted second parameter value is reflected in the parameter, thereby updating the profile to a personally customized profile.

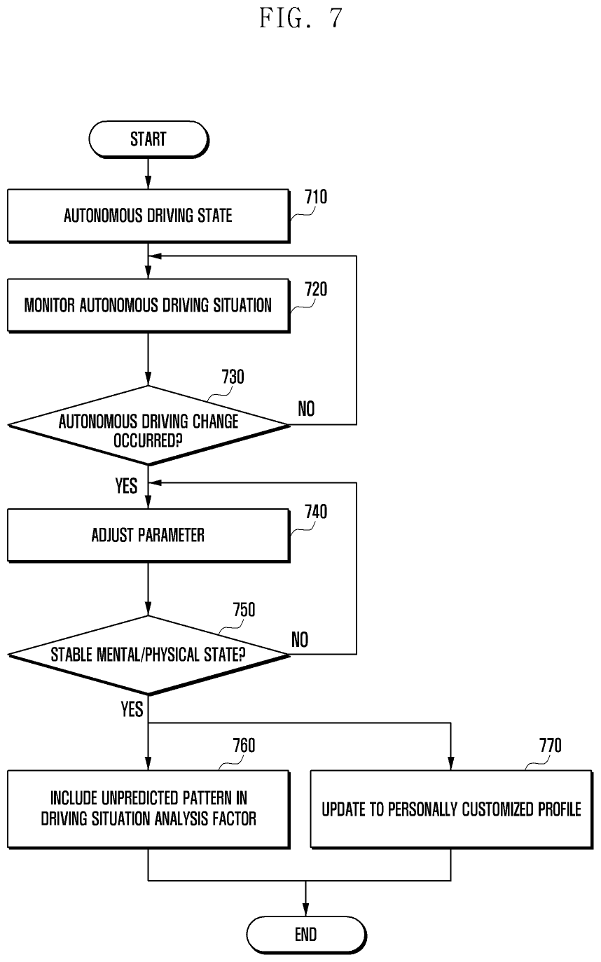

FIG. 7 illustrates a method for improving an autonomous driving profile of an autonomous vehicle according to various embodiments.

Referring to FIG. 7, according to an embodiment, the autonomous vehicle (for example, the autonomous vehicle 202 in FIG. 2 or the autonomous vehicle 501 in FIG. 5) may confirm whether control values for controlling a driving device are appropriate for the occupant such that a change in the occupant's mental/physical state is reflected while controlling the vehicle movement through autonomous driving. If the control values are not appropriate, autonomous vehicle may adjust parameters of the autonomous vehicle function to find an adjustment value that makes the occupant's mental/physical state stable, thereby supporting the profile to be updated to a personally customized profile.

In operation 710, the processor (for example, the processor 230 in FIG. 2 or the processor 550 in FIG. 5) of the autonomous vehicle may control the vehicle movement by operating a parameter for adjusting the driving device, when the vehicle is autonomously driven according to an autonomous driving profile, at a first parameter value.

In operation 720, the processor 230 or 550 may monitor the autonomous driving situation so as to analyze whether an autonomous driving change condition is detected.

As an example, the processor 230 or 550 may sense the occurrence of a problematic situation that requires parameter adjustment during autonomous driving, or a situation that the vehicle cannot predict (in other words, unpredicted pattern), and may control the vehicle movement to solve the unpredicted pattern. The processor 230 or 550 may analyze whether an unpredicted pattern occurs during autonomous driving, based on at least one of traveled road information, surrounding traffic situation information, road state information, surrounding vehicle information, or sensor information.

The occurrence of an unpredicted pattern may correspond to at least one of a situation in which the distance between adjacent vehicles is small, a situation in which the vehicle is abruptly traveling along a curved road, a situation in which braking distance adjustment has failed, a situation in which lanes are changed to avoid an obstacle, a situation in which speed or steering adjustment has failed when overtaking a preceding vehicle, a situation in which the traveling speed is changed due to an adjacent vehicle, a situation in which the road surface condition inconveniences driving, a situation in which the nervousness due to an adjacent vehicle, a situation in which an adjacent vehicle has cut in, or a situation of abrupt acceleration, for example, but is not limited thereto.

In operation 730, the processor 230 or 550 may determine whether an unpredicted pattern that the autonomous driving situation cannot predict occurs. In operation 740, the processor 230 or 550 may react to the occurrence of the unpredicted pattern and may adjust (fine-tune) the parameter of the currently executed autonomous driving function to a second parameter value.

In operation 750, the processor 230 or 550 may determine whether the occupant's mental/physical state is currently stable.

According to an embodiment, the processor 230 or 550 may receive, based on connection to an electronic device including a biometric sensor, at least one of biometric information, mental/physical state information, or mental/physical state change information from the electronic device, and may determine whether the occupant's mental/physical state is stable, based on information from the electronic device.

According to some embodiments, the processor 230 or 550 may measure biometric information through a biometric sensor mounted in the vehicle, and may determine the occupant's mental/physical state based on the biometric information, thereby determining whether the occupant's mental/physical state is stable.

If occupant's mental/physical state is unstable, the processor 230 or 550 may return to operation 740, may readjust the parameter (in other words, adjust the parameter to a third parameter value), and may again control the movement of the autonomous vehicle.

In operation 760, the processor 230 or 550 may include the unpredicted pattern in a driving situation analysis factor and may control the same to be feedbacked in a following autonomous driving situation.

For example, the processor 230 or 550 may include the unpredicted pattern in an autonomous driving monitoring problem situation such that, if the same situation occurs later, the problem situation can be avoided or automatically adjusted until the occupant's mental/physical state becomes stable.

In operation 770, in an independent or parallel manner, the processor 230 or 550 may react to a transition of the occupant's mental/physical state from an unstable state to a stable state, may identify an adjustment value (for example, second parameter value) optimized for the occupant, and may apply (or record) the adjustment value in the autonomous driving profile, thereby updating the profile to a personally customized profile.

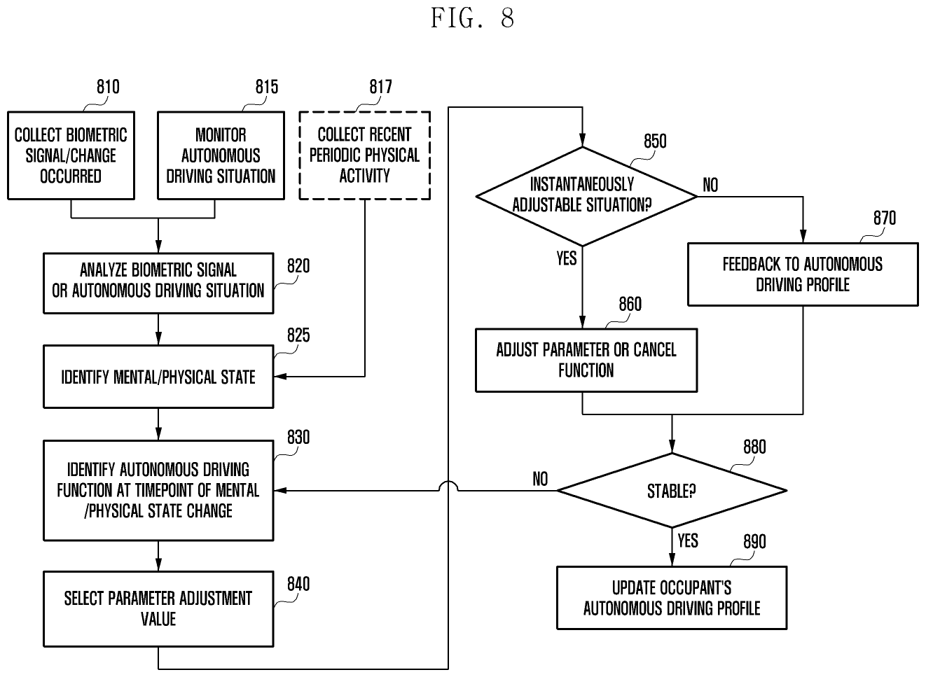

FIG. 8 illustrates a method for improving an autonomous driving profile of an autonomous vehicle according to various embodiments.

Referring to FIG. 8, according to an embodiment, the processor (for example, the processor 230 in FIG. 2 or the processor 550 in FIG. 5) of the autonomous vehicle (for example, the autonomous vehicle 202 in FIG. 2 or the autonomous vehicle 501 in FIG. 5) may collect the occupant's biometric signal in an autonomous driving state and monitor whether a change in the biometric signal occurs in operation 810.

As an example, the autonomous vehicle may acquire at least one of a biometric signal, biometric information, or mental/physical state information from a biometric sensor mounted in the vehicle or from an electronic device including a biometric sensor. As another example, the autonomous vehicle may receive, from the electronic device, mental/physical state assessment information indicating a transition of the occupant's mental/physical state from a stable state to an unstable state or vice versa.

In operation 815, the processor 230 or 550 may monitor the autonomous driving situation in the autonomous driving state.

In operation 820, the processor 230 or 550 may analyze the autonomous driving situation at a timepoint of change of the biometric signal as a result of monitoring.

In operation 825, the processor 230 or 550 may identify the occupant's mental/physical state. As an example, the processor 230 or 550 may identify whether the occupant's mental/physical state is stable or unstable. As another example, the processor 230 or 550 may identify whether the occupant's mental/physical state has transitioned from a stable state to an unstable state.

Additionally, as in operation 817, the processor 230 or 550 may collect the occupant's recent periodic physical activity information and may further assess the validity of the occupant's mental/physical state by reflecting the physical activity information. The physical activity information may be received from the electronic device. For example, the processor 230 or 550 may compare a measured biometric signal with the occupant's normal sleeping pattern so as to confirm whether the occupant is dozing in the vehicle.

In operation 830, the processor 230 or 550 may analyze the driving situation to determine the autonomous driving function that is being executed at a timepoint of change of the mental/physical state.

In operation 840, the processor 230 or 550 may identify parameters of autonomous driving and may select an adjustment value to adjust (fine-tune) parameters. For example, if the current traveling speed control value is 80 km/h, the processor 230 or 550 may determine an adjustment value such that, with reference to 80 km/h, the speed is reduced by 5 km/h or 1 km/h.

In operation 850, the processor 230 or 550 may determine whether instantaneous parameter adjustment is possible in the current situation.

For example, the processor 230 or 550 may determine that instantaneous is not possible if the vehicle has fully traveled along a curved road section, and may determine that instantaneous is possible if the vehicle is currently traveling along a curved road section.

In operation 860, the processor 230 or 550 may adjust the parameter from a first parameter value configured as a default to a second parameter value, if instantaneous parameter adjustment is possible, thereby alleviating the function or canceling the identified autonomous driving function (for example, adjust the parameter to 0).

For example, if the vehicle is currently traveling along a curved road section (that is, upon entry), the processor 230 or 550 may adjust the traveling speed to be reduced if the occupant's mental/physical state becomes unstable while traveling at the configured rotational speed.

If instantaneous adjustment is not possible, the processor 230 or 550 may feedback an adjustment value, as in operation 870, so as to change the first parameter value configured as a default in the parameter to a second parameter value such that, if the same mental/physical state change condition is detected later, vehicle movement adjustment is applied.

In operation 880, the processor 230 or 550 may determine whether occupant's mental/physical state is stable.

As an example, the processor 230 or 550 may analyze biometric information so as to determine whether the occupant's mental/physical state has transitioned from an unstable state to a stable state. As another example, the processor 230 or 550 may receive assessment information indicating a transition of the occupant's mental/physical state from an unstable state to a stable state.

If the occupant's mental/physical state is unstable, the processor 230 or 550 may return to operation 830, may identify the autonomous driving function that is being executed at the timepoint of change of the mental/physical state, and may reselect an adjustment value for parameter adjustment.

In operation 890, the processor 230 or 550 may react to a transition of the occupant's mental/physical state to a stable state and may change (or record) the parameter of the autonomous driving function from the first parameter value configured as a default to adjusted second parameter values, thereby updating the profile to a personally customized profile.

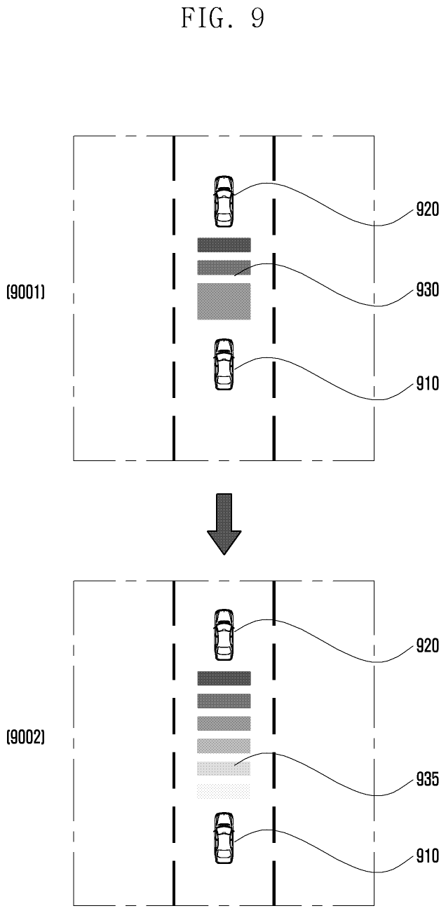

FIG. 9 illustrates an example of improving an autonomous driving profile of an autonomous driving vehicle according to various embodiments.

Referring to FIG. 9, the autonomous vehicle 910 according to an embodiment (for example, the autonomous vehicle 202 in FIG. 2 or the autonomous vehicle 501 in FIG. 5) may operate a driving device with a first parameter value configured as a default during autonomous driving, thereby controlling the vehicle movement.

As illustrated at 9001, the autonomous vehicle 910 may be autonomously driven currently, based on a straight traveling function and a function for maintaining the distance from the preceding vehicle. The function for maintaining the distance from the preceding vehicle 920 may have been configured in three sections 930.

While monitoring the occupant's mental/physical state, the autonomous vehicle 910 may sense a transition of the occupant's mental/physical state from a stable state to an unstable state, and may analyze the autonomous driving situation. For example, the occupant may feel nervous if abrupt acceleration occurs due to the function for maintaining the distance from the preceding vehicle because it is raining or because the road surface is slippery.

The autonomous vehicle 910 may sense a transition of the occupant's mental/physical state to an unstable state when the vehicle travels while maintaining the distance from the preceding vehicle in three sections 930, and may analyze the situation at the timepoint of transition of the occupant's mental/physical state in reaction to the occupant's unstable state. For example, the autonomous vehicle 910 may identify the weather situation, the road situation, and the traffic volume, thereby identifying the distance between vehicles, the braking distance, and the section of the distance from the preceding vehicle.

As illustrated at 9002 the autonomous vehicle 910 may change of adjust the distance from the preceding vehicle to six sections 935, or may adjust the parameter to a second parameter value to increase the braking distance, thereby controlling the vehicle movement.

The autonomous vehicle 910 may continuously check the occupant's mental/physical state while each element of the autonomous driving function is adjusted, thereby updating the second parameter value that makes the occupant stable in the autonomous driving profile. Accordingly, the autonomous vehicle 910 may provide the occupant with personally customized autonomous driving such that the occupant does not feel nervous in the same situation.

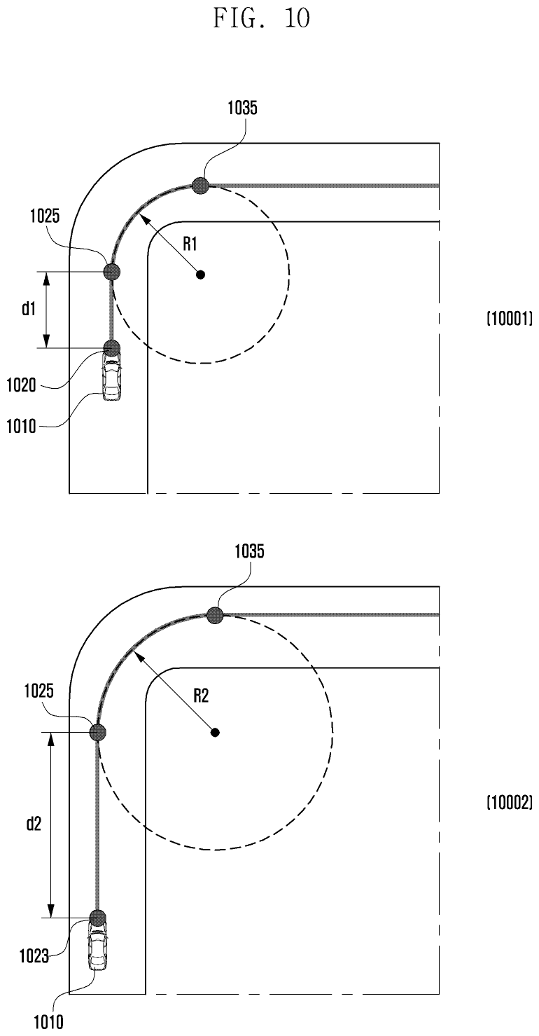

FIG. 10 illustrates an example of improving an autonomous driving profile of an autonomous driving vehicle according to various embodiments.

Referring to FIG. 10, according to an embodiment, the autonomous vehicle 910 (for example, the autonomous vehicle 202 in FIG. 2 or the autonomous vehicle 501 in FIG. 5) may execute an autonomous driving function with a configured first parameter value, thereby controlling the vehicle movement.

As illustrated at 10001, the autonomous vehicle 1010 may be autonomously driven currently, based on a curved section autonomous driving function. For example, parameters of the curved section autonomous driving function may include the entry speed and entry distance for reducing the speed when entering a curved section, a rotational radius value for curved section rotation, a curved traveling speed according to the rotational radius, and the exit speed and exit distance for acceleration in a straight section where rotation ends.

As an example, the autonomous vehicle 1010 may be driven such that the vehicle decelerates from the start point 1020 according to the entry distance d1 during curved section autonomous driving, travels along a rotation section according to the rotational radius value R1 from the rotation point 1025, and again accelerates from the increase point 10035 by means of the exit distance.

The autonomous vehicle 1010 may monitor the occupant's mental/physical state in real time in the autonomous driving situation, thereby sensing a transition of the mental/physical state to an unstable state. The autonomous vehicle 1010 may adjust the parameter to a second parameter value in reaction to sensing a transition to an unstable state, thereby individually selecting a value that makes the occupant's mental/physical state stable, and may update the same to an autonomous control profile. Alternatively, if instantaneous adjustment is possible, the autonomous vehicle 1010 may instantaneously adjust the parameter to adjustment values.

As illustrated at 10002, the autonomous vehicle 1010 may be driven such that the vehicle decelerates from the start point 1023 according to the entry distance d2 that makes the occupant's mental/physical state stable during curved section autonomous driving, travels along a rotation section according to the rotational radius value R2 from the rotation point 1025, and again accelerates from the increase point 1035 by means of the exit distance. This is only an example, and the autonomous vehicle 1010 may adjust the entry angle or exit angle.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

1. An autonomous driving control device comprising:
a sensor device comprising a biometric sensor; and
a processor,
wherein the processor is configured to:
control a parameter related to a driving device configured to control movements of an autonomous vehicle at a first parameter value when the autonomous vehicle is driven by at least one autonomous driving function;
monitor, via the biometric sensor, an occupant's mental/physical state, based on biometric information of the occupant positioned inside the autonomous vehicle, while the autonomous vehicle is driven by the autonomous driving function; and
adjust the first parameter value to a second parameter value in reaction to a transition of the occupant's mental/physical state from a stable state to an unstable state as a result of the mental/physical state monitoring.

2. The autonomous driving control device claim 1, wherein the processor is further configured to collect biometric information from the biometric sensor and confirm a transition to the unstable state in case that the mental/physical state deviates from a standard range designated as a stable state, based on the biometric information.

3. The autonomous driving control device claim 1, wherein the autonomous driving function comprises at least one of a straight road traveling function, a curved road traveling function, an evasive steering function, a forward collision prevention function, a lane departure prevention function, a function for maintaining a distance from a preceding vehicle, an entry/exit lane traveling function, a rear collision prevention function, a lane change function, or a speed adjusting function, and
wherein the parameter comprises at least one of a rate of traveling acceleration, a rate of traveling deceleration, a curve entry speed or rotational speed, a curve entry angle or rotational angle, a braking distance, a collision distance, a brake sensitivity, a steering sensitivity, a maximum speed, g-force, a seat adjustment value, a suspension frequency, or a steering angle.

4. The autonomous driving control device claim 1, wherein the processor is further configured to:
identify an autonomous driving function which is currently executed at a timepoint of transition of the occupant's mental/physical state to an unstable state; and
adjust the parameter associated with the autonomous driving function which is currently executed at the timepoint of transition of the occupant's mental/physical state to the unstable state to the second parameter value and update the adjusted second parameter value as a default configuration regarding the currently executed autonomous driving function.

5. The autonomous driving control device claim 4, wherein the processor is further configured to increase/decrease the parameter from the first parameter value so as to correspond to the type of the currently executed autonomous driving function, based on a transition of the occupant's mental/physical state to the unstable state, such that the parameter is adjusted to the second parameter value.

6. The autonomous driving control device claim 1, wherein the processor is further configured to:
operate the driving device with the second parameter value after adjustment to the second parameter value such that movements of the autonomous vehicle are controlled; and
readjust the second parameter value to a third parameter value until the occupant's mental/physical state becomes stable in case that the occupant's mental/physical state remains unstable as a result of monitoring the mental/physical state.

7. The autonomous driving control device claim 1, wherein the processor is further configured to change an autonomous driving function currently executed at a timepoint of transition of the occupant's mental/physical state to the unstable state to a different autonomous driving function, and control movements of the autonomous vehicle with a parameter value corresponding to the changed different autonomous driving function.

8. The autonomous driving control device claim 1, wherein the processor is further configured to:
monitor a driving situation while the autonomous vehicle moves during autonomous driving; and
determine whether the occupant's mental/physical state is unstable at a timepoint of detection of an unpredicted pattern which causes an abrupt movement of the autonomous vehicle as a result of monitoring the driving situation.

9. The autonomous driving control device claim 8, wherein the driving situation at the timepoint at which the occupant's mental/physical state has become unstable is updated as the unpredicted pattern of monitoring.

10. The autonomous driving control device claim 1, wherein the processor is further configured to:
request an electronic device to provide the occupant's physical activity pattern; and
compare the physical activity pattern received from the electronic device to a previously captured physical activity pattern of the occupant so as to determine whether the occupant's mental/physical state is valid.

11. An autonomous driving control device comprising:
a communication module; and
a processor operatively connected to the communication module,
wherein the processor is configured to:
connect to an electronic device of an occupant positioned inside an autonomous vehicle through the communication module;
control a parameter related to a driving device configured to control movements of the autonomous vehicle at a first parameter value when the autonomous vehicle is driven by at least one autonomous driving function;
identify a transition of the occupant's mental/physical state from a stable state to an unstable state, based on biometric information obtained from the electronic device, while being driven by the autonomous driving function; and
adjust the first parameter value to a second parameter value in reaction to a transition of the occupant's mental/physical state from the stable state to the unstable state.

12. The autonomous driving control device claim 11, wherein the processor is further configured to adjust the first parameter value to the second parameter value such that the occupant's mental/physical state becomes stable, in reaction to receiving first information indicating a transition of the occupant's mental/physical state from the stable state to the unstable state from the electronic device.

13. The autonomous driving control device claim 11, wherein the processor is further configured to:
control a communication connection to be established with the electronic device through the communication module according to a condition that the occupant's electronic device is positioned inside the autonomous vehicle, a condition that the electronic device is positioned within a preconfigured distance from the autonomous vehicle, or the occupant's request,
receive the occupant's biometric information from the electronic device, based on the communication connection to the electronic device, and
readjust the second parameter value to a third parameter value until second information indicating that the occupant's mental/physical state has become stable is received from the electronic device after adjusting the first parameter value to the second parameter value.

14. The autonomous driving control device claim 11, wherein the processor is further configured to:
request the electronic device to provide the occupant's physical activity pattern; and
compare the physical activity pattern received from the electronic device to a previously captured physical activity pattern of the occupant so as to determine whether the occupant's mental/physical state is valid.

15. An autonomous driving control device comprising:
a memory; and
a processor operatively connected to the memory,
wherein the memory comprises instructions which, during autonomous driving, cause the processor to:
operate a parameter related to a driving device at a first parameter value according to at least one autonomous driving function so as to control movements of an autonomous vehicle;
monitor an occupant's mental/physical state, based on biometric information of an occupant positioned inside the autonomous vehicle; and
adjust the first parameter value to a second parameter value such that the occupant's mental/physical state becomes stable in reaction to a transition of the occupant's mental/physical state from a stable state to an unstable state as a result of monitoring the biometric information.
